(19) United States
(12) Patent Application Publication
(10) Pub. No.: US 2014/0150923 A1
(43) Pub. Date: Jun. 5, 2014

(54) ARRANGEMENT AND METHOD FOR INJECTING A FLUID INTO AN ANALYSIS APPLIANCE

(71) Applicant: CTC ANALYTICS AG, Zwingen (CH)

(72) Inventors: Peter STALDER, Fehren (CH); Lucas LUETHY, Zuerich (CH)

(21) Appl. No.: 14/096,830

(22) Filed: Dec. 4, 2013

(30) Foreign Application Priority Data
Dec. 5, 2012 (EP) 12 405 125.1

(51) Int. Cl. G01N 30/18

(52) U.S. Cl. CPC G01N 30/18
USPC 141/1; 141/329

(57) ABSTRACT

Arrangement and method for injecting a fluid into an analysis appliance, in particular into a liquid chromatograph with an injection opening. The arrangement includes a manipulating device with an injection needle, and a seal, in particular a ferrule, which is made of a polymer material and is arranged removably on the injection opening. In the axial direction, the seal has a guide bore for receiving the injection needle. The guide bore includes a shoulder with an opening, of which the diameter is smaller than a diameter in a first portion of the guide bore extending from the shoulder in the direction of a first end of the seal. The injection needle can be inserted into the guide bore from the direction of the first end of the seal, and the front edge of the injection needle can be pressed onto the shoulder with a predetermined force.

### TECHNICAL FIELD

The invention relates to an arrangement and a method for injecting a fluid into an analysis appliance, in particular into a liquid chromatograph with an injection opening, in particular with an injection valve, and to an analysis appliance with such an arrangement.

### PRIOR ART

Arrangements and methods of this kind are already known in the prior art. For example, WO 2012/010222 (Agilent Technologies Inc.) discloses a biocompatible insert for a fluidic device, in particular for an HPLC appliance. The insert connects a capillary to the inlet of the HPLC appliance and has a first sealing element with a first contact surface, which can be connected to the capillary, and with a second contact surface, which can be connected to the inlet of the HPLC appliance. In one illustrative embodiment, the first contact surface is designed in such a way that it is connected to the front area of the capillary, wherein the front edge of the capillary is pressed onto the first contact surface. The first contact surface extends in the lateral direction in front of the front edge of the capillary, wherein the first contact surface forms an abutment surface for the capillary when said capillary is inserted into the inlet of the HPLC appliance. The first contact surface can be made of a biocompatible plastic, in particular of PEEK, and can be connected to the capillary either in a fixed or a removable manner. The insert can also have a second sealing element, which is composed of two ferrules lying one above the other in the axial direction. One of these ferrules can have an annular spring, which applies a force to the capillary in the axial direction.

DE 10 2009 022 368 (Dionex Softron GmbH) describes a plug unit for the connection of capillaries, in particular for high-performance liquid chromatography. The plug unit comprises a sealing element which is arranged at the end of a plug capillary and which engages around the plug capillary, wherein a front end face of the sealing element is flush with the end face of the plug capillary. The sealing element is enclosed in a rear area by a pressure piece and is connected fixedly with respect to axial movements relative to the plug capillary. By the compression of the sealing element in the very front area thereof, a sealing action is obtained at the end face of the plug capillary, wherein a sealing action with respect to the inner wall of the capillary-receiving opening is also additionally obtained in the radial direction. The sealing element can be elastic, so as to engage with pretensioning around the plug capillary in the front area. The sealing element is connected to the pressure piece via a base part.

U.S. Pat. No. 4,690,437 (Dionex Softron GmbH) discloses a connection element for connecting a fluid conduit to a fluid inlet of an appliance or of a further fluid conduit. The connection element comprises a ferrule made of a deformable material, wherein this ferrule can be pushed at one end over the fluid conduit and can be mounted at the other end onto an inlet. Moreover, the connection element comprises a screw-in fastening element with an axial bore, which widens conically at the front end in order to be able to enclose the rear end of the ferrule. The ferrule is preferably made of plastic having good compatibility with chemicals.

WO 2011/076244 (Agilent Technologies Inc.) discloses a connection element for a fluidic device, in particular for an HPLC appliance. The connection element has a tube, at the front end of which an insert is fitted that seals the connection between the tube and the inlet of the fluidic device. The insert is preferably made of a deformable polymer, in particular of PEEK.

A disadvantage of these previously known arrangements is that, in order to achieve a good sealing action, the capillaries have to be pressed with sufficient force into the seals by means of screw connections. This makes it impossible to use seals of this kind in automatic systems in which the capillaries are guided to the injection opening of an analysis appliance without the involvement of an operator, e.g: by a movable arm. Moreover, the use of a screw connection is problematic, since the force exerted on the capillary can only be roughly adjusted, and this can lead to leaks at the connection or to damage of the capillary.

Moreover, in connection with automatic systems, sealing arrangements are used in which a capillary is guided through an axial opening of a ferrule directly to an injection opening of an analysis appliance, wherein the ferrule provides lateral sealing of the capillary. However, a basic disadvantage of such systems is that a dead volume may remain between the end of the ferrule and the injection opening. A dead volume of this kind not only makes the measurements inaccurate in quantitative analyses, it can also lead to cross-over of material between individual measurements.

### DISCLOSURE OF THE INVENTION

The problem addressed by the invention is to create an arrangement which belongs to the technical field mentioned at the outset and which permits a good sealing action without a dead volume, particularly in automatic injection systems.

The solution to the problem is defined by the features of Claim 1. According to the invention, an arrangement for injecting a fluid into an analysis appliance, in particular into a liquid chromatograph with an injection opening, in particular with an injection valve, comprises a manipulating device with an injection needle. Moreover, the arrangement has a seal, in particular a ferrule, which is made of a polymer material and is arranged removably on the injection opening. In the axial direction, the seal has a guide bore for receiving the injection needle, wherein the guide bore is designed in such a way that it comprises a shoulder with an opening. The diameter of the opening is smaller than a diameter in a first portion of the guide bore extending from the shoulder in the direction of a first end of the seal. The manipulating device has means that are suitable for inserting the injection needle into the guide bore from the direction of the first end of the seal and for pressing the front edge of the injection needle onto the shoulder with a predetermined force.

By pressing the injection needle onto the shoulder with a predetermined force, a good sealing action is obtained at the front end of the injection needle. Since the injection needle is sealed off at the front end, no dead volume can form between the injection needle and the injection opening, which dead volume could cause a quantitative measurement to be rendered false or could cause material to cross over between two measurements. In addition, the predetermined force can be chosen in such a way that a good sealing action is achieved without the injection needle or the seal being damaged by too great a force being applied.

In the present application, “manipulating device” is understood as any device with which an injection needle can be moved in space. The movement of the injection needle preferably takes place independently, i.e. the manipulating device has suitable drive means and a control system that permits a movement of the injection needle. Alternatively, however, the manipulating device can also be adjustable by hand. It is particularly preferable if the insertion of the injection needle into the guide bore and the means for pressing the injection needle onto the shoulder with the predetermined force are controlled by the same control system that also controls the manipulating device. Preferably, by means of the manipulating device, the injection needle can additionally be positioned above at least one sample container, such that a fluid sample to be analyzed can be drawn into the injection needle.

The injection needle is preferably fluidically connected to a suitable pump device, with the aid of which the fluid to be analyzed can be ejected from the injection needle and/or can be drawn up into the latter. It is particularly preferable if the injection needle is connected to a plunger syringe by a cannula. Between the injection needle and the pump device, a cannula is preferably arranged that has a volume corresponding to the volume of fluid to be analyzed, such that contamination of the pump device by the fluid sample is prevented. This is preferably a sample loop which can receive the entire volume of the fluid to be analyzed.

To achieve a particularly good sealing action, the front end of the injection needle is preferably cut at right angles, i.e. the entire periphery of the needle end lies on a plane at right angles to the longitudinal center axis of the injection needle. Alternatively, other geometries of the needle end are conceivable, although a good sealing action can be achieved only if the shoulder inside the guide bore has a geometry matching the needle end.

The injection needle is preferably made of steel, in particular of stainless steel or of a steel alloy. The external diameter of the needle preferably lies between 0.2 mm and 2 mm, particularly preferably between 0.5 mm and 0.8 mm, said external diameter very particularly preferably being 0.72 mm. However, injection needles of larger diameter can also be used depending on the intended application. The internal diameter of the needle is preferably between 0.1 mm and 0.6 mm, particularly preferably between 0.2 mm and 0.45 mm.

The seal preferably comprises a chemically resistant and/or biocompatible polymer material. Such seals can be produced relatively easily and cost-effectively, and the use of a slightly elastic polymer material provides an excellent sealing action since irregularities at the front end of the injection needle can be compensated by the elastic property of the material.

The seal preferably has the form of a ferrule. Ferrules are known to a person skilled in the art in the field of chromatography and have at least in part a conical shape. However, the seal can also be in the form of a cylinder or of any desired polyhedron. The axial guide bore is preferably arranged point-symmetrically in the radial plane of the seal.

The shoulder in the guide bore is preferably arranged at right angles to the inner wall of the guide bore. This results in a particularly good sealing action, particularly in combination with the front end of the injection needle being cut at right angles. Between the diameters of the opening and of the guide bore, there is preferably a difference that corresponds to at least twice the wall thickness of the injection needle, wherein the opening is arranged concentrically inside the guide bore. This ensures that the injection needle, at its front end, is pressed onto the shoulder across the entire width of its side wall, such that the sealing action is maximized. This also has the effect that the opening of the shoulder is connected without transition to the lumen of the injection needle inserted into the guide bore, as a result of, which contamination of the shoulder by the fluid is prevented. In addition, this allows the fluid to be injected in what is substantially a laminar stream, since there is no turbulence caused by edges projecting into the stream of fluid. If needles having lumens of different diameter are to be able to be used with the same seal, the diameter of the opening should be chosen such that it is the same size as the average of the lumen diameters of the injection needles that can be used with the seal. In this way, a good compromise between the sealing action and the flow behavior of the fluid can be achieved. In a particularly preferred embodiment, the diameter of the opening is 0.35 mm.

To generate the predetermined force, the manipulating device has a suitable means for applying the corresponding force to the injection needle.

In the context of this application document, “predetermined force” is understood as a force which is constant over time or which is variable according to a parameter. Particularly preferably, the force is regulated variably according to the injection pressure, with one determined force being applied for each injection pressure. This makes it possible to adapt the applied force to the pressure profile during the injection, such that an optimal sealing action is achieved at all times. The force to be used for each inserted needle can be determined in advance by experiment or on the basis of simulations and can be stored in a control unit for the manipulating device. The optimal force to be used can then be read out on the basis of a measurement of the injection pressure. Moreover, the force can also be regulated according to other parameters, e.g. time, injection volume, temperature or viscosity of the fluid.

The seal is preferably made of polyether ether ketone (PEEK). Polyether ether ketone is a thermoplastic which has good resistance to chemicals and also has very great mechanical stability. Moreover, polyether ether ketone also has good compatibility with biological samples, such that seals made of polyether ether ketone can be used for a great many different applications. Alternatively, however, the seal can also be made of another chemically resistant polymer, e.g. polytetra-fluoroethylene (PTFE).

In the first portion, the diameter of the guide bore preferably has a constant diameter, which corresponds substantially to an external diameter of the injection needle.

In the context of this application document, “substantially” means that the diameter of the guide bore is exactly large enough to allow insertion of the injection needle, without play arising between the outer wall of the injection needle and the inner wall of the guide bore. It is thus ensured that the injection needle is precisely guided in the guide bore and, in this way, an optimal positioning of the front end of the injection needle on the shoulder is obtained.

Alternatively, the diameter in the first portion can also vary. For example, it can decrease continuously toward the shoulder, or the first portion can have two sub-portions with different diameters.

In a second portion which extends from the shoulder to the second end of the seal, which end bears on the injection opening when the seal is arranged on the latter, the diameter of the guide bore is preferably smaller than the diameter of the guide bore in the first portion. The diameter in the second portion is particularly preferably the same size as the diameter of the opening.

The effect of this is that there is virtually no shear flow between the opening and the second portion of the guide bore. Particularly when injecting a fluid containing quite large biomolecules, such as proteins or DNA strands, a shear flow could cause these to fragment. Moreover, the shoulder of such a seal is substantially more stable, since forces acting on it can be distributed to the material lying underneath. This eliminates the danger of the shoulder breaking off when the injection needle is pressed onto it.

Alternatively, however, the diameter in the second portion can be larger than the diameter of the opening, in particular the same size as the diameter in the first portion.

The guide bore preferably has, in the first portion, a diameter of 0.2 mm to 2.0 mm, preferably of 0.5 mm to 0.8 mm. This permits the use of conventional injection needles in liquid and gas chromatography, which increases the compatibility between the arrangement and existing analysis appliances and keeps down the costs of disposable items.

Moreover, the opening preferably has a diameter of 0.1 mm to 1.8 mm, preferably of 0.2 mm to 0.6 mm. In connection with conventional injection needles in liquid and gas chromatography, this results in a shoulder whose width is great enough to generate an optimal sealing action with the front end of the injection needle. Moreover, commercially available injection needles have lumens with diameters of this kind, as a result of which a continuous fluid conduit with a constant diameter can be generated from the injection needle through the opening to the injection opening of the analysis appliance. This means that a fluid injected into an analysis appliance with the aid of a device according to the invention is not subjected to any great turbulent flow or to any changes of speed, as happens in a fluid conduit with changing diameters.

Alternatively, the diameters can of course also have other values depending on the application, in particular values that are greater than the preferred values.

Preferably, the means of the manipulating device are designed in such a way that the injection needle can be pressed onto the shoulder with a predetermined force of 1 N to 50 N, preferably of 15 N to 25 N.

It has been found that, by pressing the injection needle with a force in this range, a particularly good sealing action can be achieved without the injection needle or the seal being damaged by the effect of the force.

Alternatively, the front end of the injection needle can also be pressed onto the shoulder with greater forces, in which case the injection needle must be made correspondingly more stable.

The means of the manipulating device are preferably designed as a drive, with which the injection needle is movable in a first spatial direction, which is parallel to the guide bore.

By means of this drive, the injection needle can be inserted into and drawn back out of the guide bore. Particularly preferably, the drive is at the same time designed in such a way that the injection needle can be subjected to a predeterminable and in particular constant force in order to press it onto the shoulder. The drive can be an electrical, pneumatic, hydraulic or magnetic drive. The use of a drive has the advantage that the predetermined value of the force can be relatively easily adjusted according to the application, without individual parts of the manipulating device having to be changed, as would be the case when using a spring element.

A manipulating device of this kind can be used particularly in conjunction with a carousel for sample vials, wherein an opening, instead of a sample vial, is arranged at a position on the carousel and clears the way to the injection opening of an analysis appliance. In this way, an arrangement can be made available which requires only a simple movement of the injection needle in one spatial direction and, by virtue of the rotation of the carousel, can nevertheless inject a large number of samples automatically into an analysis appliance. Preferably, the carousel also has a position at which the injection needle can be rinsed, in order to avoid cross-over of a sample fluid.

It is very particularly preferable to use a servo motor that has a suitable control system, so as to be able to apply a predetermined and in particular constant force to the injection needle. A motor control system of this kind is disclosed in DE 10 2009 022 314 from the applicant, for example.

Alternatively, the means can also be designed as a spring element with a suitable spring force. A predetermined force can be transmitted relatively easily to the injection needle in this way. However, a disadvantage is that the manipulating device needs to have, in addition to the spring, a device with which the injection needle can be inserted into the guide bore. In addition, the resilience of a spring decreases over time as a sign of wear, as a result of which a constant predetermined force can be generated by a spring only for a certain period of time.

The manipulating device is preferably driveable in at least one further spatial direction, which is orthogonal to the first spatial direction.

In this way, in addition to the injection needle being able to be inserted into the guide bore and removed again therefrom by the manipulating device, it can also be driven to at least one further position. This makes it possible, for example, to position the injection needle over a sample container in order to draw up a fluid sample.

Particularly preferably, the manipulating device is designed in such a way that the injection needle can be moved in all three spatial directions. In this case, the manipulating device can be designed in particular as an XYZ pipetting robot. It is thus possible, for example, for different fluid samples to be drawn up in succession from a microtiter plate into the injection needle and injected into an analysis appliance. Moreover, the injection needle can also be driven to a rinsing position, in which the injection needle can be cleaned with a rinsing solution. Alternatively, the manipulating device can also be designed in such a way that the injection needle can additionally be pivoted about at least one axis.

A further aspect of the present invention concerns a method for injecting a fluid into an analysis appliance with an injection opening, in particular with an arrangement according to the invention.

The method according to the invention comprises a first step of arranging a seal with an axial guide bore on the injection opening, in particular on an injection valve of an analysis appliance. The guide bore has a first portion with a first diameter, and also a shoulder with an opening with a second diameter, which is smaller than the first diameter.

In a next step, an injection needle, which has an external diameter corresponding substantially to the first diameter of the guide bore, is inserted into the first portion of the guide bore until the front end of the injection needle abuts the shoulder.

The injection needle is then pressed onto the shoulder with a predetermined force, and the fluid is injected from the injection needle into the injection opening.

A good sealing action can be easily generated by the method according to the invention, particularly in automatic injection systems in which a plurality of fluid samples are injected in succession with the same injection needle. By pressing the injection needle onto the shoulder, sealing takes place at the front end of the injection needle, without a dead volume arising between the injection needle and the injection opening. This means there is as good as no cross-over of material between two fluid samples.

The predetermined force is preferably from 1 N to 50 N, preferably from 15 N to 25 N. It has been found that, by pressing the injection needle on with a force in this range, a particularly good sealing action can be achieved without the injection needle or the seal being damaged by the force applied.

The seal is preferably fixed on the injection opening by application of a holder, in particular by an injection port, and is pressed by this holder onto the injection opening.

It is thus ensured that the seal sits securely on the injection opening and is tightly connected thereto. The holder is particularly preferably screwed onto the analysis appliance. This permits a particularly good fit with a good sealing action between the seal and the injection opening.

Alternatively, the seal can also be held on the injection opening by other means. For example, the seal can be screwed directly into a corresponding recess of an analysis appliance by means of a thread arranged on the outer surface of the seal.

A further aspect of the present invention concerns an analysis appliance with an injection opening, in particular with an injection valve for a fluid, with at least one arrangement according to the invention. An advantage of an analysis appliance of this kind is that it can be very easily used in an automated system.

The analysis appliance preferably has, in the area of the injection opening, a recess into which the seal can be fitted in such a way that the guide bore is arranged coaxially with respect to the injection opening.

It is thus possible to ensure that the seal can be exchanged as easily and as quickly as possible, without the complication of having to align the guide bore with the injection opening.

Moreover, the analysis appliance has fastening means for a holder with which the seal can be fixed on the injection opening. The holder is particularly preferably designed such that it subjects the seal to a force which leads to sealing between the seal and an area of the analysis appliance that immediately surrounds the injection opening.

Further advantageous embodiments and combinations of features of the invention will become clear from the following detailed description and from all of the patent claims.

### BRIEF DESCRIPTION OF THE DRAWINGS

In the drawings used to explain the illustrative embodiment:

FIG. 1 shows a sectional view through a seal fitted in a recess,

FIG. 2 shows a sectional view through an arrangement according to the invention,

FIG. 3 shows a perspective view of a seal, and

FIG. 4 shows a horizontal section through a seal in the area of the first portion.

Identical parts are in principle provided with the same reference signs in the figures.

### WAYS OF IMPLEMENTING THE INVENTION

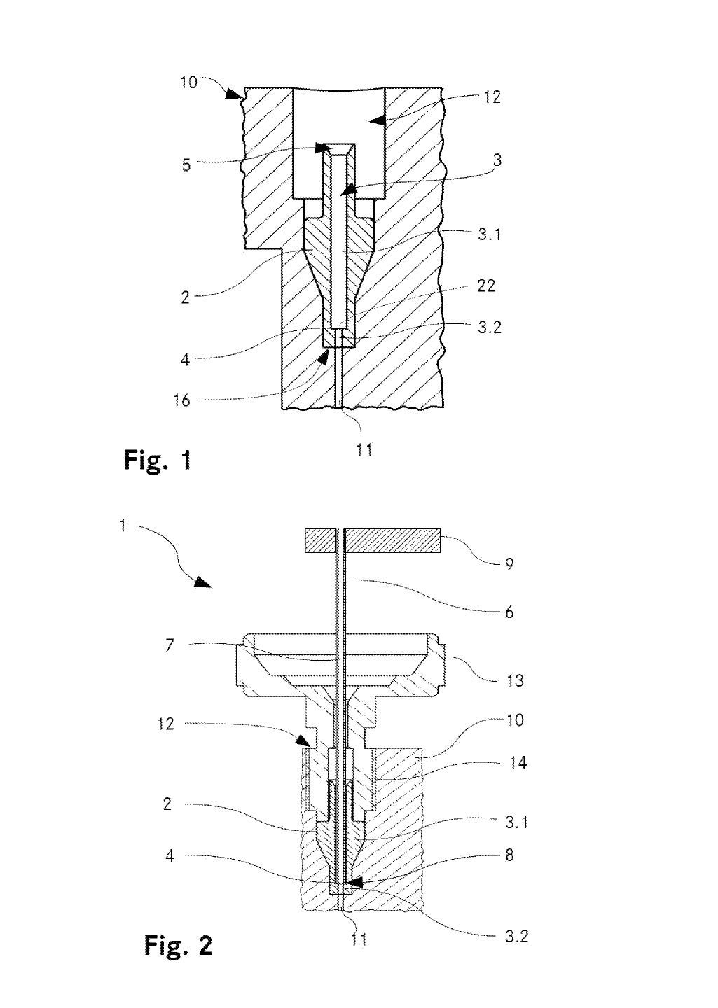

FIG. 1 shows a sectional view of a seal 2, which is fitted in a recess 12 of an analysis appliance 10. The seal 2 has an axial guide bore 3, which extends axially from a first end 5 to a second end 16 of the seal 2. A shoulder 4 with an opening 22 is arranged inside the guide bore 3. In a first portion 3.1, which extends from the shoulder 4 in the direction of the first end 5 of the seal 2, the guide bore 3 has a first diameter, which is greater than the diameter of the opening 22. In a second portion 3.2, which extends from the shoulder in the direction of the second end 16 of the seal 2, the guide bore 3 has a second diameter, which corresponds to the diameter of the opening 22. The recess 12 is designed in such a way that, with the seal 2 fitted, the guide bore 3 is coaxial to an injection opening 11 of the analysis appliance 10.

To permit a more precise insertion of an injection needle into the guide bore 3, the first end 5 of the guide bore 3 has a funnel shape. In this way, even when an injection needle is not positioned quite exactly, said injection needle can still be easily inserted into the guide bore 3.

FIG. 2 shows a sectional view of an arrangement 1 according to the invention. In the guide bore 3, an injection needle 6 is inserted in the first portion 3.1. The injection needle 6 is connected to a manipulating device 9, with which the injection needle 6 can be inserted from the direction of the first end 5 into the guide bore 3. The manipulating device 9 is designed in such a way that the injection needle 6 is pressed with its front end 8 onto the shoulder 4 with a predefined and in particular constant force. By pressing the front end 8 of the injection needle 6 onto the shoulder 4, a very good, but still releasable sealing connection is obtained between the injection needle 6 and the seal 2. The fact that the sealing takes place directly at the front end 8 of the injection needle means that no dead volume can arise between the seal 2 and the injection needle 6.

The difference in size of the diameters in the first portion 3.1 of the guide bore 3 and of the opening 22 is chosen such that it corresponds to twice the wall thickness of the injection needle 6. In this way, the lumen 7 of the injection needle 6 and the injection opening 11 of the analysis appliance 10 form a continuous fluid conduit of constant diameter. This allows a fluid to be injected into the analysis appliance 10 in a stream that is as laminar as possible.

In the embodiment shown, the seal is fixed in the recess 12 by a holder 13, which is designed as an injection port. The holder 13 is connected to the analysis appliance 10 by a thread 14. A pressure can be applied to the seal 2 by the holder 13 via the thread 14, and this pressure leads to good sealing between the seal 2 and an area of the analysis appliance 10 surrounding the injection opening 11.

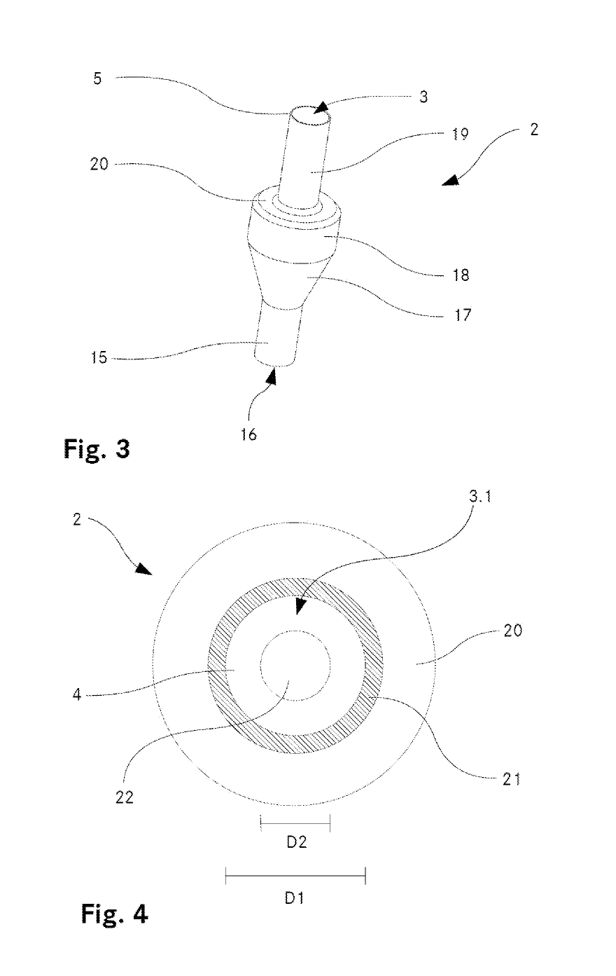

FIG. 3 shows a perspective view of a seal 2. The seal has the form of a ferrule, as is customary in chromatography and as is known to a person skilled in the art in this field. In the area of the front end 16, the seal 2 has the shape of a cylinder. In the direction of the second end, the seal 2 widens in a conical area, which merges into a cylindrical middle area 18. The middle area 18 has a bearing surface 20 which is oriented in the direction of the first end 5. The bearing surface 20 serves as a contact surface between the seal 2 and a holder 13 of an analysis appliance 10. In the area of the first end 5, the seal is once again formed in the shape of a cylinder.

FIG. 4 shows a horizontal section through a seal 2 in the first portion 3.1 of the guide bore 3 of an arrangement 1 according to the invention. The differences in size between the diameter D2 of the opening 22 and the diameter D1 of the first portion 3.1 of the guide bore 3 can be clearly seen. The difference in size between the two diameters D1 and D2 is chosen so as to correspond to twice the wall thickness of the injection needle 6 used. It is thus ensured that the injection needle 6 bears with its front end 8 completely on the shoulder 4. FIG. 4 also shows a cross section of the wall 21 of the seal 2, and a plan view of the bearing surface 20.

The seal 2 can also have a three-dimensional shape different than the ferrule shown in the illustrative embodiments. In particular, the seal can be designed along its entire length as a cylinder. The seal 2 can in particular be adapted to a manufacturer-specific shape, such that it can be fitted in recesses 12 of analysis appliances 10 from different manufacturers. Moreover, the holder 13 can also be present in a form other than the injection port shown, e.g. as a grub screw or the like.

1-14. (canceled)

15. Arrangement for injecting a fluid into an analysis appliance, in particular into a liquid chromatograph, comprising a manipulating device with an injection needle and a seal made of a polymer material, said seal being removably arranged on an injection opening of the analysis appliance and having a guide bore in an axial direction for receiving the injection needle, wherein the guide bore comprises a shoulder with an opening with a diameter smaller than a diameter in a first portion of the guide bore, said first portion extending from the shoulder in the direction of a first end of the seal, and wherein the manipulating device has means for inserting the injection needle into the guide bore from the direction of the first end of the seal and for pressing a front edge of the injection needle onto the shoulder with a predetermined and constant force.

16. Arrangement according to claim 15, wherein the seal is made of polyetheretherketone.

17. Arrangement according to claim 15, wherein the first portion of the guide bore has a constant diameter which corresponds to an external diameter of the injection needle.

18. Arrangement according to claim 15, wherein said guide bore comprises a second portion which extends from the shoulder to the second end of the seal, said second end bearing on the injection opening when said seal is arranged on said injection opening, said second portion having a diameter which is smaller than the diameter of the guide bore in the first portion.

19. Arrangement according to claim 15, wherein the diameter of the guide bore in the first portion is from 0.2 mm to 2.0 mm.

20. Arrangement according to claim 15, wherein the means of the manipulating device are configured such that the injection needle is pressed onto the shoulder with a predetermined force of 1 N to 50 N.

21. Arrangement according to claim 15, wherein the means of the manipulating device is a drive with which the injection needle is movable in a first spatial direction which is parallel to the guide bore.

22. Arrangement according to claim 21, wherein the manipulating device is driveable in at least one further spatial direction, which is orthogonal to the first spatial direction.

23. Method for injecting a fluid into an analysis appliance with an injection opening, said method comprising the steps of:
a) arranging a seal with an axial guide bore on the injection opening, wherein the guide bore comprises a first portion with a first diameter and a shoulder with an opening having a second diameter which is smaller than said first diameter;
b) inserting an injection needle with an external diameter corresponding to the first diameter of the guide bore into the first portion of the guide bore until a front end of the injection needle abuts on said shoulder;
c) pressing the injection needle onto said shoulder with a predetermined and constant force;
d) injecting the fluid into the injection opening.

24. Method according to claim 23, wherein the injection needle is pressed onto the shoulder with a predetermined force of 1 N to 50 N.

25. Method according to claim 23, wherein the seal is releasably arranged on the injection opening by application of a holder and is pressed by this holder onto an area of the analysis appliance surrounding the injection opening.

26. Analysis appliance with an injection opening for a fluid with at least one arrangement according to claim 15.

27. Analysis appliance according to claim 26, wherein the analysis appliance has a recess in the area of the injection opening into which recess the seal is fitted in such a way that the guide bore is arranged coaxially with respect to the injection opening.

28. Analysis appliance according to claim 26, wherein the analysis appliance has fastening means for a holder with which the seal is fixed on the injection opening.

29. Arrangement according to claim 18, wherein the diameter of the guide bore in the second portion has the same size as the diameter of the opening.

30. Analysis appliance with an injection opening for a fluid with at least one arrangement according to claim 16.

31. Analysis appliance with an injection opening for a fluid with at least one arrangement according to claim 17.

32. Analysis appliance with an injection opening for a fluid with at least one arrangement according to claim 18.

33. Analysis appliance with an injection opening for a fluid with at least one arrangement according to claim 19.

34. Analysis appliance with an injection opening for a fluid with at least one arrangement according to claim 20.
